(19) United States
(12) Patent Application Publication
(10) Pub. No.: US 2009/0049060 A1
(43) Pub. Date: Feb. 19, 2009

(54) Method and Apparatus for Managing Database Records Rejected Due to Referential Constraints

(76) Inventors: Rafal Przemyslaw Konik, Oronoco, MN (US); Mark William Theuer, Rochester, MN (US); Michael Alan Venz, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/837,788

(22) Filed: Aug. 13, 2007

(51) Int. Cl. G06F 17/30

(52) U.S. Cl. 707/100; 707/E17.001

(57) ABSTRACT

Embodiments of the invention provide techniques for managing database records rejected due to referential constraints. In one embodiment, such rejected records may be processed automatically. More specifically, the foreign key value included in a rejected record may be automatically added to a parent table, and the rejected record may then be re-inserted into the destination table. In another embodiment, rejected records may be stored in a rejection queue. The rejected records may be presented to a user in a graphical user interface (GUI). The GUI may be configured to enable the user to update the parent table to include the missing foreign key value. Additionally, the GUI may be configured to enable the user to select specific records to be inserted into their respective destination tables.

### BACKGROUND OF THE INVENTION

1. Field of the Invention

The invention generally relates to computer database systems. More particularly, the invention relates to techniques for managing rejected database records.

2. Description of the Related Art

Databases are well known systems for storing, searching, and retrieving information stored in a computer. The most prevalent type of database used today is the relational database, which stores data using a set of tables that may be reorganized and accessed in a number of different ways. Users access information in relational databases using a relational database management system (DBMS).

Each table in a relational database includes a set of one or more columns. Each column typically specifies a name and a data type (e.g., integer, float, string, etc.), and may be used to store a common element of data. For example, in a table storing data about patients treated at a hospital, each patient might be referenced using a patient identification number stored in a “patient ID” column. Reading across the rows of such a table would provide data about a particular patient. Tables that share at least one attribute in common are said to be “related.” Further, tables without a common attribute may be related through other tables that do share common attributes. A path between two tables is often referred to as a “join,” and columns from tables related through a join may be combined to from a new table returned as a set of query results.

In relational databases, one technique for maintaining data integrity is to use a referential constraint, which requires that a foreign key of one table must match another table's parent key. More specifically, a first table (hereafter referred to as “dependent table”) includes a foreign key field, and the values stored in the foreign key field must also be present in a parent key field of a second table (hereafter referred to as “parent table”).

Referential constraints may be enforced when new records are inserted into a table. For example, a record being inserted into a dependent table may include a value in a foreign key field that is not present in the parent key of the parent table, and is thus rejected for violating the referential constraint. Conventionally, most databases are not configured to handle such rejected records, and the data contained in those records may thus be lost.

Therefore, there is a need for improved techniques for processing database records rejected due to referential constraints.

### SUMMARY OF THE INVENTION

Embodiments of the invention generally provide techniques for processing rejected database records.

One embodiment of the invention provides a computer-implemented method for processing rejected records of a database, comprising: receiving a record rejected due to a lack of a parent key required by one or more referential constraints; determining a substitute parent key suitable to fulfill the one or more referential constraints; and updating a parent table to include the determined substitute parent key.

Another embodiment of the invention provides a computer-readable storage medium containing a program which, when executed, performs an operation. The operation comprises: receiving a record rejected due to a lack of a parent key required by one or more referential constraints; determining a substitute parent key suitable to fulfill the one or more referential constraints; and updating a parent table to include the determined substitute parent key.

Yet another embodiment of the invention provides a system, comprising: a processor; and a memory containing a program configured to compose a query of hierarchical data by performing an operation. The operation comprises: receiving a record rejected due to a lack of a parent key required by one or more referential constraints; determining a substitute parent key suitable to fulfill the one or more referential constraints; and updating a parent table to include the determined substitute parent key.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram that illustrates a client server view of computing environment, according to one embodiment of the invention.

FIG. 2 illustrates an exemplary referential constraint, according to one embodiment of the invention.

FIG. 3 is a flow diagram illustrating a method for automatically processing rejected database records, according to one embodiment of the invention.

FIG. 4 is a flow diagram illustrating a method for processing rejected database records according to user input, according to one embodiment of the invention.

FIG. 5 illustrates a display screen of a graphical user interface (GUI) for managing rejected records, according to one embodiment of the invention.

### DETAILED DESCRIPTION OF THE PREFERRED EMBODIMENTS

Embodiments of the invention provide techniques for processing rejected database records. Conventionally, records being inserted into a destination table may be rejected if they include a foreign key value that is not included in a parent key field of a parent table. In one embodiment, such rejected records may be processed automatically. More specifically, the foreign key value included in a rejected record may be automatically added to the parent table, and the rejected record may then be re-inserted into the destination table. In another embodiment, rejected records may be stored in a rejection queue. The rejected records may be presented to a user in a graphical user interface (GUI). The GUI may be configured to enable the user to update the parent table to include the missing foreign key value. Additionally, the GUI may be configured to enable the user to select specific records to be inserted into their respective destination tables. These embodiments may enable rejected records to be successfully inserted into destination tables, and may thus reduce the loss of the data included in the rejected records.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive and DVDs readable by a DVD player) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

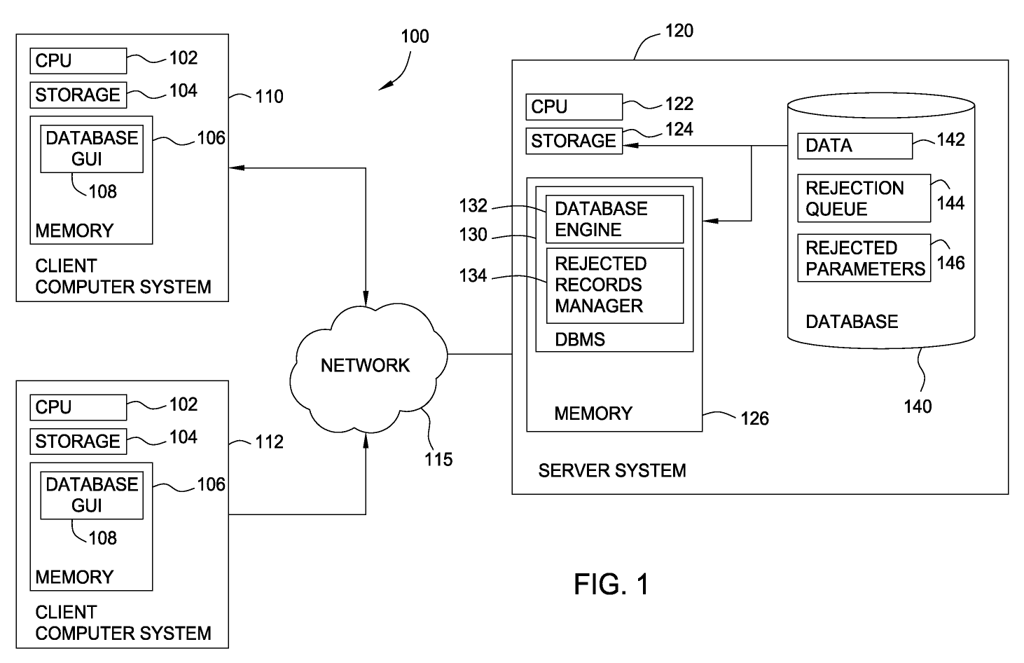

FIG. 1 is a block diagram that illustrates a client server view of computing environment 100, according to one embodiment of the invention. As shown, computing environment 100 includes two client computer systems 110 and 112, network 115 and server system 120. In one embodiment, the computer systems illustrated in environment 100 may include existing computer systems, e.g., desktop computers, server computers laptop computers, tablet computers, and the like. The computing environment 100 illustrated in FIG. 1, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

As shown, client computer systems 110 and 112 each include a CPU 102, storage 104 and memory 106, typically connected by a bus (not shown). CPU 102 is a programmable logic device that performs all the instruction, logic, and mathematical processing in a computer. Storage 104 stores application programs and data for use by client computer systems 110 and 112. Storage 104 includes hard-disk drives, flash memory devices, optical media and the like. The network 115 generally represents any kind of data communications network. Accordingly, the network 115 may represent both local and wide area networks, including the Internet.

The client computer systems 110 and 112 are also shown to include a database GUI 108. In one embodiment, the database GUI 108 is software application that allows end users to interact with and manage a database (e.g., database 140). Accordingly, in one aspect of the database GUI 108, users may compose and submit a query to a database system, which, in response, may be configured to process the query and return a set of query results. The database GUI 108 may be configured to compose queries in a database query language, such as Structured Query Language (SQL). However, it should be noted that the query tool 108 is only shown by way of example; any suitable requesting entity may submit a query (e.g., another application, an operating system, etc.).

In one embodiment, the server 120 includes a CPU 122, storage 124, memory 126, a database 140, and a database management system (DBMS) 130. As shown, the database 140 may include data 142, rejection queue 144, and rejection parameters 146. The data 142 represents the substantive data stored by the database 140. At various times, elements of the database 140 may be present in storage 124 and memory 126.

The DBMS 130 provides a software application used to organize, analyze, and modify information stored in the database 140. As shown, the DBMS 130 includes a query engine 132 and a rejected records manager 134. The query engine 132 may be configured to process database queries submitted by a requesting application (e.g., a query generated using database GUI 108) and to return a set of query results to the requesting application.

In one embodiment, the rejected records manager 134 may be configured to manage database records that are rejected during insertion into a destination table for violating referential constraints, meaning that they include a foreign key value that is not included in a parent key field of a parent table. More specifically, the rejected records manager 134 may be configured to store rejected records to prevent data loss, to correct the underlying referential constraint violations, and to re-insert them into their respective destination tables.

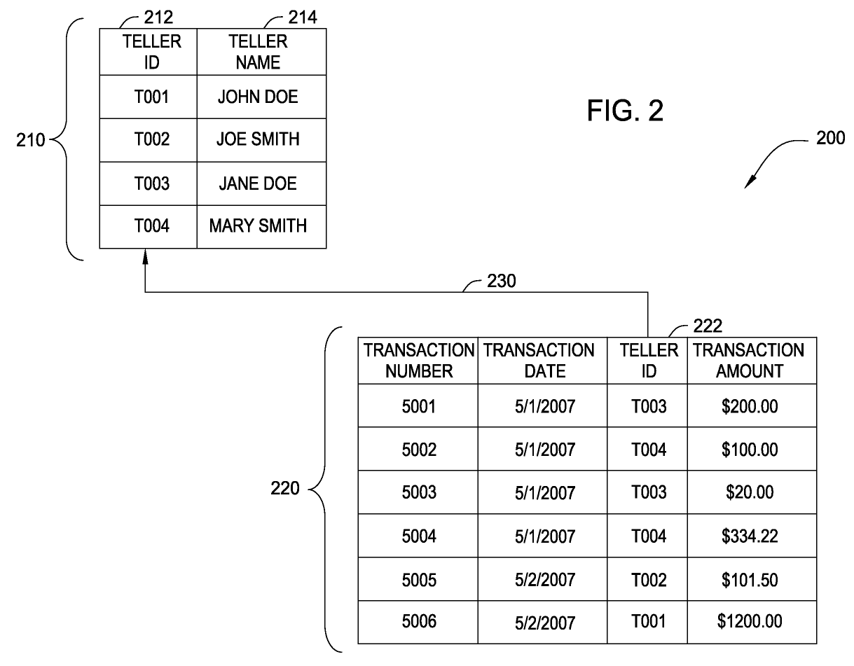

FIG. 2 illustrates an exemplary referential constraint, according to one embodiment of the invention. As shown, dependent table 220 is linked by a referential constraint 230 to parent table 210. That is, the dependent table 220 includes a foreign key 222 (i.e., the “TELLER ID” column), which must only include values that are also present in a parent key 212 of a parent table 210. Thus, in this example, if any records inserted into the dependent table 220 include foreign key 222 values that are not present in the parent key 212 of parent table 210, those records will be rejected (i.e., not inserted) to maintain the referential constraint 230.

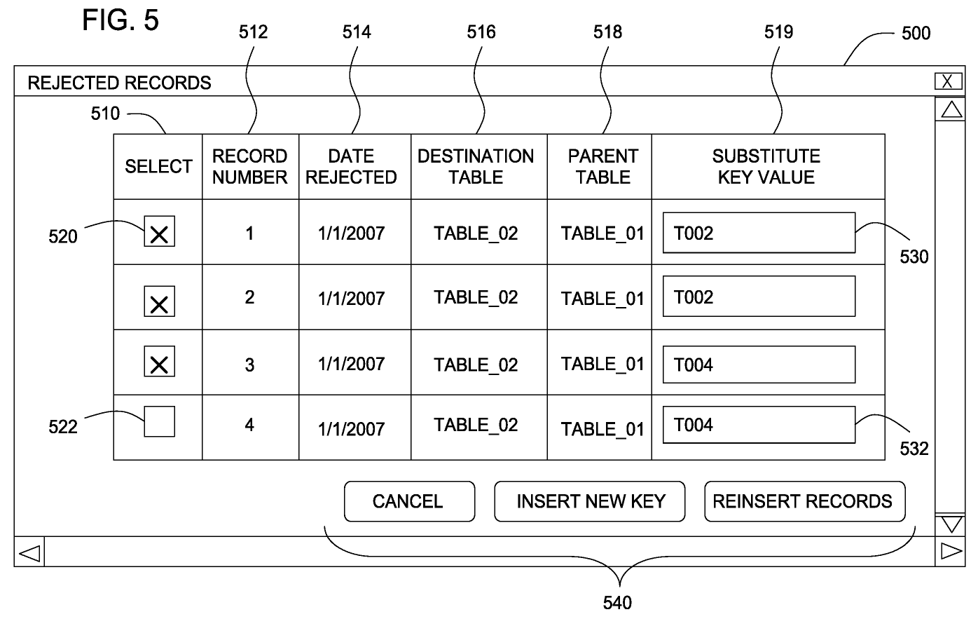

Returning now to FIG. 1, the rejected records manager 134 may store the rejected records in the rejection queue 144 until the referential constraint problems that caused the rejection can be corrected. In one embodiment, the database GUI 108 may be configured to enable a user to view the contents of the rejection queue 144 and to select specific records for recovery (i.e., correction of referential constraint problems and reinsertion into destination tables). An example of such a GUI is discussed below with reference to FIG. 5.

In another embodiment, any rejected records may be handled by the rejected records manager 134 automatically (i.e., without requiring user interaction) according to the rejection parameters 146. The rejection parameters 146 may specify whether, in the event of a record rejection due to a referential constraint, the foreign key value that caused the rejection is automatically added to the parent table. The rejection parameters 146 may further specify the handling of rejected records at various levels of database objects (e.g., for a parent table, for a destination table, for a referential constraint, or the database as a whole).

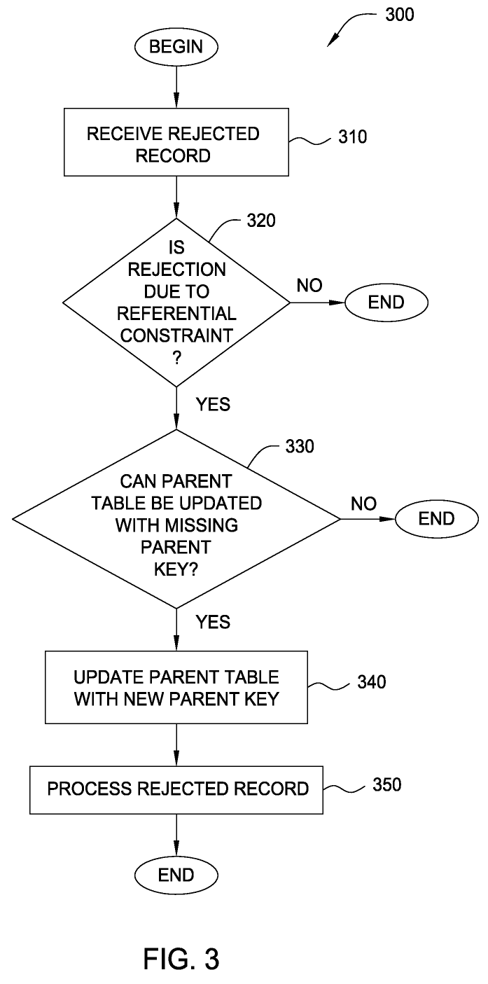

FIG. 3 is a flow diagram illustrating a method 300 for automatically processing rejected database records, according to one embodiment of the invention. The method 300 begins at step 310, by receiving a record that is rejected while being inserted into a destination table.

At step 320, it is determined whether the record was rejected because it violates a referential constraint of the destination table into which it was inserted. For example, as illustrated in FIG. 2, a record inserted into the dependent table 220 which includes a foreign key 222 value that is not present in the parent key 212 of parent table 210 may be rejected (i.e., not inserted) because it violates the referential constraint 230. If so, the method 300 continues at step 330. Otherwise, the record is not applicable to the method 300, and the method 300 ends.

At step 330, it is determined whether the parent table can be updated with a new record that includes the missing parent key value. If so, the method 300 continues at step 340. Otherwise, the method 300 ends. The step 330 may be determined by evaluating a rejection parameter 146 that specifies whether automatic update of the parent key is allowed. Such rejection parameters may be configured to control the automatic update of the parent keys for various elements of the database, such as a parent table, a dependent table, the entire database, etc.

At step 340, the parent table is updated with a new record that includes the missing parent key. For example, the parent table 210 shown in FIG. 2 may be updated with a new record having a value in parent key 212 that matches the value of the foreign key 222 that caused the rejection. At step 350, the rejected record is reinserted into the destination table (e.g., dependent table 220 shown in FIG. 2). Since the foreign key value of the rejected record now has a valid parent key, the record will be inserted successfully (i.e., without being rejected for violating the referential integrity). After step 350, the method 300 ends.

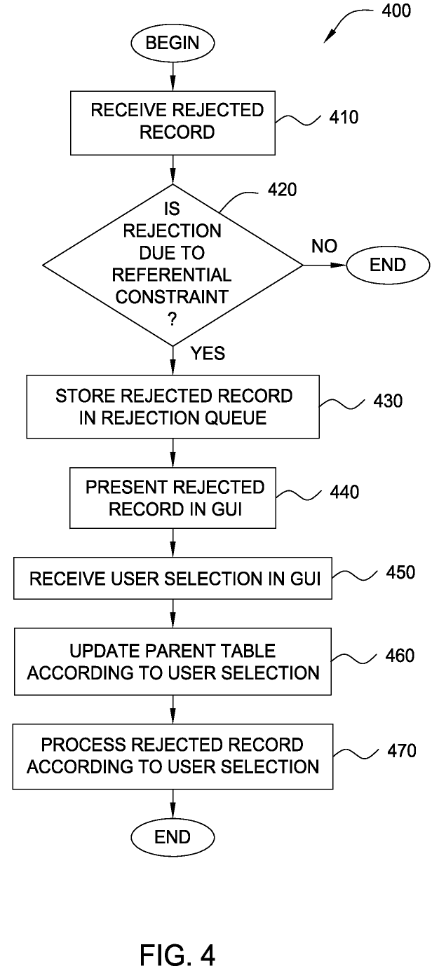

FIG. 4 is a flow diagram illustrating a method 400 for processing rejected database records according to user input, according to one embodiment of the invention. The method 400 begins at step 410, by receiving a record that is rejected while being inserted into a destination table.

At step 420, it is determined whether the record was rejected because it violates a referential constraint of the destination table into which it was inserted. For example, as illustrated in FIG. 2, a record inserted into the dependent table 220 which includes a foreign key 222 value that is not present in the parent key 212 of parent table 210 may be rejected (i.e., not inserted) because it violates the referential constraint 230. If so, the method 400 continues at step 430. Otherwise, the record is not applicable to the method 400, and the method 400 ends.

At step 430, the rejected record is stored in a rejection queue. In one embodiment, the rejection queue may include all records which have been rejected during insertion into destination tables due to referential constraint violations. The rejection queue may also store, along with the rejected record, additional data describing the rejected record and the rejection event, for example a record source, a time stamp, a destination table, etc. The rejection queue may be configured as a stand-alone table of a database (e.g., the rejection queue 144 illustrated in FIG. 1). However, the rejection may be configured in any other suitable form, for example as part of another table of the database 140, or as a temporary structure within memory 126.

At step 440, the rejected record may be presented to a user in a graphical user interface (GUI) (e.g., database GUI 108 illustrated in FIG. 1). The GUI may also present information describing the reject records, for instance a date when the record was rejected, a destination table name, a current status of the record, and the like. In one embodiment, the GUI may be configured to enable a user to view the contents of the rejection queue (e.g., rejection queue 144) and to select specific records for recovery (i.e., correction of referential constraint problems and reinsertion into destination tables). An example of a GUI configured for managing rejected records is illustrated in FIG. 5, which is discussed in further detail below.

At step 450, a user selection of a substitute primary key is received in the GUI. At step 460, the user selection of a substitute primary key is used to update the rejected record(s) of the rejection queue. At step 470, the updated records of the rejection queue are processed, such that the records are inserted in their respective destination tables. After step 470, the method 400 ends. Thus, by use of the method 400, a user may update any rejected records such that they may be properly inserted into their destination table (as if they had not been rejected), while maintaining the referential integrity of the table.

FIG. 5 illustrates a display screen of a graphical user interface (GUI) 500 for managing rejected records, according to one embodiment of the invention. In one embodiment, the GUI 500 may be viewed by a user of a client computer (e.g., client computer 110 shown in FIG. 1). The GUI 500 may be included in a GUI configured for general interaction with a database (e.g., the database GUI 108 interacting with database 140, as shown in FIG. 1).

In one embodiment, the GUI 500 may be configured to display any records rejected due to referential constraints. For example, the GUI 500 may display the contents of a rejected records queue (e.g., rejection queue 144 illustrated in FIG. 1). As shown, the GUI 500 may be configured to display the rejected records as rows of a grid, with columns describing characteristics of each record. In this example, the GUI 500 includes a selection column 510, a record number column 512, a date rejected column 514, a destination table column 516, a parent table column 518, and a substitute key value column 529.

The selection column 510 may be configured with controls (e.g., checkboxes) to enable users to select specific records for further action (i.e., correction of referential constraint problems and reinsertion into destination tables). In this example, the selection column 510 includes a checkbox 520, which a user has checked, indicating that the record corresponding to checkbox 520 is selected for further action. In contrast, the checkbox 522 has not been checked, indicating that the record corresponding to checkbox 522 has not been selected for further action at this time.

In one embodiment, the record number column 512 may store a number of a specific rejected record, and a date rejected column 514 may indicate a date when the record was rejected. The destination table column 516 may store the name of the destination table for the rejected record (e.g., dependent table 220 shown in FIG. 2). The parent table column 518 may store the name of the table which includes the parent key of the referential constraint (e.g., parent table 210 shown in FIG. 2).

In one embodiment, the substitute key value column 519 may initially include a recommended value of a parent key value that may be added to the parent table to resolve the referential constraint causing a record to be rejected. More specifically, the recommended value added to the parent table may be the foreign key value of the rejected record. In another embodiment, the substitute key value column 519 may be configured to include data fields to enable a user to enter a new parent key value, or to modify a recommended parent key value. For example, the data field 530 includes the parent key value “T002,” while the data field 532 includes the parent key value “T004.” The parent key value entered or modified in the data fields by the user may be added to the parent table. Thus, by adding the foreign key value to the parent key of the parent table, the referential constraint will be resolved, and the rejected record may be successfully reinserted into the destination table. The user may interact with the GUI 500 via graphical user controls, for example the control buttons 540 shown in FIG. 5. The control buttons 540 may enable the user to perform typical functions in the GUI 500, such as executing commands, cancelling commands, and the like.

Of course, GUI 500 is provided for illustrative purposes only. It is contemplated that a GUI used for managing rejected records may be configured in any beneficial manner. Further, users may manage rejected records by means other than a GUI, for instance text commands entered in a command line interface.

While the foregoing is directed to embodiments of the present invention, other and further embodiments of the invention may be devised without departing from the basic scope thereof, and the scope thereof is determined by the claims that follow.

What is claimed is:

1. A computer-implemented method for processing rejected records of a database, comprising:
receiving a record rejected during an access operation on the database, the record being rejected due to a lack of a parent key required by one or more referential constraints on the database; and
responsive to the record being rejected:
determining a substitute parent key suitable to fulfill the one or more referential constraints; and
updating a parent data structure in the database to include the determined substitute parent key.

2. The computer-implemented method of claim 1, wherein the record is rejected during an insertion into a data structure of the database, and further comprising:
inserting the rejected record into the data structure of the database including the updated parent table.

3. The computer-implemented method of claim 1, wherein determining a substitute parent key comprises determining a foreign key value of the rejected record that is not included in the parent key of the parent data structure.

4. The computer-implemented method of claim 1, wherein updating a parent data structure to include the determined substitute parent key is limited by one or more predefined rejection parameters, wherein the one or more predefined rejection parameters specify structures of the database that can be used to update the parent data structure, and wherein the specified structures of the database are selected from columns, tables, constraints, and the database.

5. The computer-implemented method of claim 1, wherein determining a substitute parent key comprises receiving a substitute parent key from a user.

6. The computer-implemented method of claim 5, further comprising, prior to determining a substitute parent key:
storing the rejected record in a rejected record queue; and
presenting a user with a graphical user interface comprising the one or more records of the rejected records queue.

7. The computer-implemented method of claim 6, wherein the graphical user interface further comprises a recommended substitute parent key for each of the one or more records of the rejected records queue.

8. A computer-readable storage medium containing a program which, when executed, performs an operation, comprising:
receiving a record rejected due to a lack of a parent key required by one or more referential constraints;
determining a substitute parent key suitable to fulfill the one or more referential constraints; and
updating a parent data structure to include the determined substitute parent key.

9. The computer-readable storage medium of claim 8, wherein the record is rejected during an insertion into a data structure of the database, and wherein the operation further comprises:
inserting the rejected record into the data structure of the database.

10. The computer-readable storage medium of claim 8, wherein determining a substitute parent key comprises determining a foreign key value of the rejected record that is not included in the parent key of the parent data structure.

11. The computer-readable storage medium of claim 8, wherein updating a parent data structure to include the determined substitute parent key is limited by one or more predefined rejection parameters, wherein the one or more predefined rejection parameters specify structures of the database that can be used to update the parent data structure, and wherein the specified structures of the database are selected from columns, tables, constraints, and the database.

12. The computer-readable storage medium of claim 8, wherein determining a substitute parent key comprises receiving a substitute parent key from a user.

13. The computer-readable storage medium of claim 12, wherein the operation further comprises, prior to determining a substitute parent key:
storing the rejected record in a rejected record queue; and
presenting a user with a graphical user interface comprising the one or more records of the rejected records queue.

14. The computer-readable storage medium of claim 13, wherein the graphical user interface further comprises a recommended substitute parent key for each of the one or more records of the rejected records queue.

15. A system, comprising:
a processor; and
a memory containing a program configured to compose a query of hierarchical data by performing an operation, comprising:
receiving a record rejected due to a lack of a parent key required by one or more referential constraints;
determining a substitute parent key suitable to fulfill the one or more referential constraints; and
updating a parent data structure to include the determined substitute parent key.

16. The system of claim 15, wherein the record is rejected during an insertion into a data structure of the database, and wherein the operation further comprises:
inserting the rejected record into the data structure of the database.

17. The system of claim 15, wherein determining a substitute parent key comprises determining a foreign key value of the rejected record that is not included in the parent key of the parent data structure.

18. The system of claim 15, wherein updating a parent data structure to include the determined substitute parent key is limited by one or more predefined rejection parameters, wherein the one or more predefined rejection parameters specify structures of the database that can be used to update the parent data structure, and wherein the specified structures of the database are selected from columns, tables, constraints, and the database.

19. The system of claim 15, wherein determining a substitute parent key comprises receiving a substitute parent key from a user.

20. The system of claim 19, wherein the operation further comprises, prior to determining a substitute parent key:
storing the rejected record in a rejected record queue; and
presenting a user with a graphical user interface comprising the one or more records of the rejected records queue.

21. The system of claim 20, wherein the graphical user interface further comprises a recommended substitute parent key for each of the one or more records of the rejected records queue.
